(19) United States
(12) Patent Application Publication
(10) Pub. No.: US 2007/0003255 A1
(43) Pub. Date: Jan. 4, 2007

(54) Apparatus and method for converting output picture

(76) Inventor: Sung-Bo Oh, Suwon-si (KR)

Correspondence Address: STEIN, MCEWEN & BUI, LLP, 1400 EYE STREET, NW, SUITE 300, WASHINGTON, DC, 20005, US

(21) Appl. No.: 10/569,430

(22) PCT Filed: Aug. 12, 2004
(86) PCT No.: PCT/KR04/02026

§ 371 Date: Feb. 23, 2006

(30) Foreign Application Priority Data
Aug. 25, 2003 (KR) 10-2003-0058785

(51) Int. Cl. H04N 7/26

(52) U.S. Cl. 386/112

(57) ABSTRACT

A method of converting an output picture, useable by a digital versatile disk (DVD) player connected to a digital television via a communication cable includes receiving output picture conversion information after data communication with the digital television commences; transmitting predetermined image picture information to the digital television while an output image of the DVD reproducing signal is being converted in response to the output picture conversion information; and interrupting the transmission of the picture information and transmitting the converted output picture to the digital television when the conversion of the output picture is completed. The abnormal picture generated while the resolution or the aspect ratio of the output image is being converted is blocked, and a predetermined picture is output to prevent viewing the abnormal picture.

### TECHNICAL FIELD

The present invention relates to an apparatus and method for driving a digital versatile disk (DVD) player, and more particularly, to an apparatus and a method for converting an output picture, which blocks an abnormal image generated while a resolution or an aspect ratio of an image is converted and outputs a predetermined image in its place.

### BACKGROUND ART

FIG. 1 is a diagram of a conventional apparatus that converts an output picture. Referring to FIG. 1, the apparatus includes a digital versatile disk (DVD) player 100, a digital visual interface (DVI) connector 101, a DVI cable 102, and a digital television 103. The DVI cable 102 transmits a digital image signal output from the DVD player 100 to the digital television 103. The digital image signal output from the DVD player 100 is transmitted to the digital television 103 via the DVI connector 101 and the DVI cable 102.

FIG. 2 is a block diagram illustrating a process of resolution conversion. The DVD player 100 initially transmits the output picture with a resolution of 480×720 to the digital television 103. Thereafter, the resolution is converted into 720×1280 in the DVD player 100 in response to a user. The DVD player 100 converts the resolution 720×1280, and outputs an abnormal image to the digital television 103 while the resolution is being converted. When the conversion of the resolution is complete, the DVD player 100 outputs an image with the resolution of 720×1280 to the digital television 103.

FIG. 3 is a block diagram illustrating a process of aspect ratio conversion. The DVD player 100 initially transmits the output picture with an aspect ratio of 4:3 to the digital television 103. Thereafter, the user converts the aspect ratio from 4:3 to 16:9 on the DVD player 100. Then, while the DVD player 100 converts the aspect ratio, an abnormal image is transmitted to the digital television 103. When the conversion of the aspect ratio is complete, the DVD player 100 outputs an image with the aspect ratio of 16:9 to the digital television 103.

As described above, abnormal images are output to the digital television 103 during the conversion of the resolution and the aspect ratio by the DVD player 100 conventionally.

### DISCLOSURE OF INVENTION

### Technical Solution

The present invention provides an apparatus and method for converting an output picture, by which an abnormal picture generated during a conversion of a resolution or an aspect ratio of a picture is blocked and instead a predetermined picture is output.

### Advantageous Effects

As described above, according to the preferred embodiments of the present invention, the abnormal picture generated while the resolution or the aspect ratio of the output image is being converted is blocked, and a predetermined image is output to prevent the user from viewing the abnormal picture.

### DESCRIPTION OF DRAWINGS

FIG. 1 is a diagram of a conventional apparatus that converts an output picture;

FIG. 2 is a block diagram illustrating a process of resolution conversion in the apparatus of FIG. 1;

FIG. 3 is a block diagram illustrating a process of aspect ratio conversion in the apparatus of FIG. 1;

FIG. 4 is a block diagram of an apparatus that converts an output picture according to a first embodiment of the present invention;

FIG. 5 is a block diagram illustrating a process of resolution or aspect ratio conversion using the apparatus of FIG. 4; and

FIG. 6 is a flow chart illustrating a method of converting an output picture according to a second embodiment of the present invention.

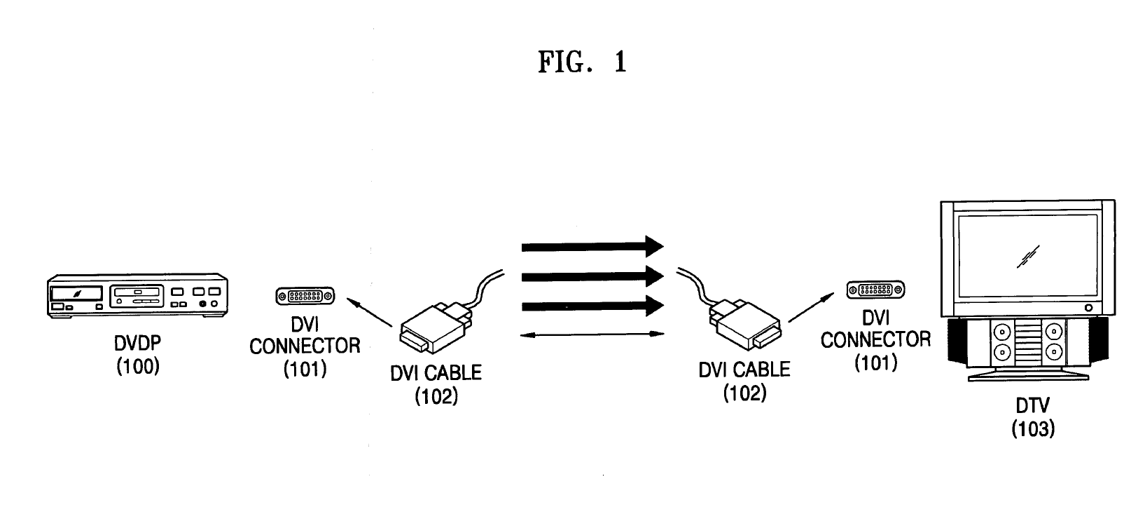

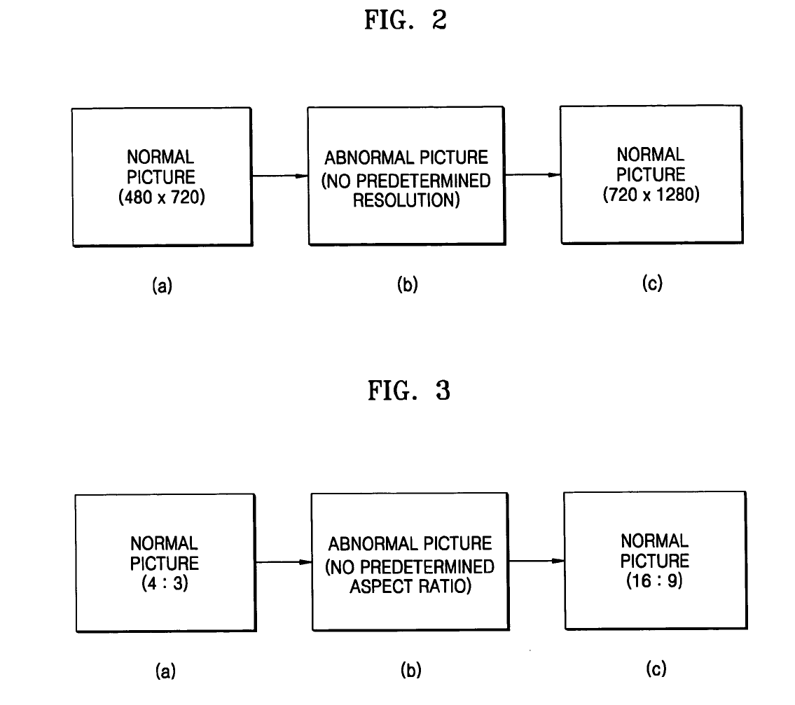

### BEST MODE

According to an aspect of the present invention, there is provided an apparatus for converting an output picture, which is a digital versatile disk (DVD) player connected to a digital television through a predetermined communication cable, the apparatus including a memory storing predetermined picture information, a signal conversion unit converting an output picture of a DVD reproducing signal by a controlling signal, and a controlling unit checking whether the cable is connected to the digital television and data communication can be performed with the digital television or not, receiving output picture conversion information of the digital television, outputting a controlling signal for converting the output picture of the DVD reproducing signal according to the output picture conversion information, and transmitting picture information stored in the memory to the digital television during the output picture is converted.

According to another aspect of the present invention, there is provided a method for converting an output picture, which is a driving method of a DVD player connected to a digital television through a predetermined communication cable, the method including (a) receiving output picture conversion information of the digital television, after a data communication is performed with the digital television, (b) transmitting predetermined image picture information to the digital television during an output picture of a DVD reproducing signal according to the output picture conversion information, and (c) stopping the transmission of the picture information and transmitting the converted output picture to the digital television, when the output picture conversion is completed.

### Mode for Invention

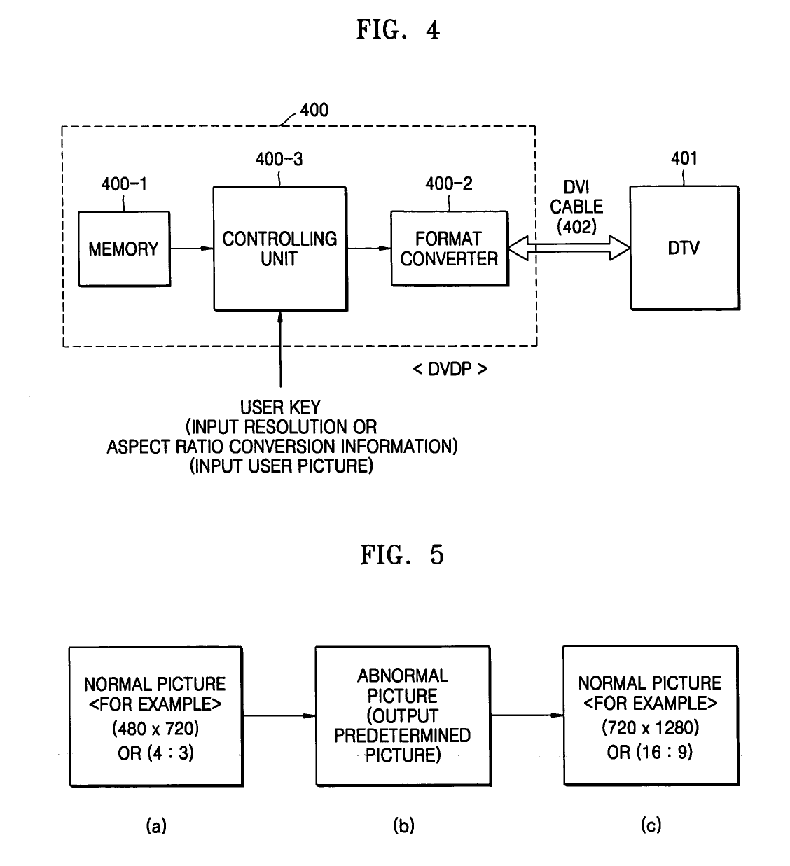

FIG. 4 is a block diagram of an apparatus that converts an output picture according to a first embodiment of the present invention. Referring to FIG. 4, the apparatus according to the first embodiment of the present invention includes a digital versatile disk (DVD) player 400, and a digital television 401. The DVD player 400 and the digital television 401 are connected by a digital visual interface (DVI) cable 402 The DVD player 400 includes a memory 400-1, a signal conversion unit 400-2, and a controlling unit 400-3.

The present invention will now be described in more detail with reference to FIGS. 4 through 6.

In the conventional apparatus, an abnormal picture is output during the resolution or aspect ratio conversion. Therefore, if a black picture or predetermined picture information is output instead of the abnormal picture, the image quality can be improved.

The DVD player 400 and the digital television 401 are connected by the DVI cable 402, which transmits digital image data through DVI communication and high-definition nultimedia interface (HDMI) communication. Although it is not shown in FIG. 4, the DVI cable 402 includes three data channels for transmitting the digital image data, a clock channel for transmitting a clock signal, and a hotplug channel for determining whether the DVI cable 402 is connected to the DVD player 400 and the digital television 401. Here, the number of channels can be increased according to the requirements of the apparatus.

The controlling unit 400-3 of the DVD player 400 determines whether the DVI cable 402 is connected to the digital television 401. Here, the controlling unit 400-3 can determine whether the DVI cable 402 is connected to the digital television 401 via the hotplug channel of the DVI cable 402.

For example, when the controlling unit 400-3 receives a 5V signal via the hotplug channel, the controlling unit 400-3 determines that the DVI cable 402 is connected to the digital television 401. However, if the controlling unit 400-3 receives a 0V signal, the controlling unit 400-3 determines that the DVI cable 402 is not connected to the digital television 401 and outputs a message to be displayed to the user.

The DVD player 400 and the digital television 401 perform communication via the DVI cable 402, and the controlling unit 400-3 is able to determine whether the data communication can be performed with the digital television 401 via the data channel of the DVI cable 402.

When the DVI cable 402 is connected to the digital television 401, and the data communication with the digital television 401 can be performed, the controlling unit 400-3 transmits a DVD reproducing signal to the digital television 401 via the data channels of the DVI cable 402

Thereafter, the controlling unit 400-3 may receive output picture conversion information such as the resolution conversion or the aspect ratio conversion information from the user. When the controlling unit 400-3 receives the output picture conversion information via a user key, the signal conversion unit 400-2 converts the DVD reproducing signal in response to the output picture conversion information.

While the DVD reproducing signal is being converted, the controlling unit 400-3 accesses the memory 400- 1. The memory 400-1 stores picture information, and can store the image input by the user. Therefore, while the DVD reproducing signal is being converted, the controlling unit 400-3 transmits a discretionary picture from the picture information stored in the memory 400-1 to the digital television 401 via the DVI cable 402. However, if the picture information is not stored in the memory 400-1, the controlling unit 400-3 transmits the black picture to the digital television 401.

FIG. 5 is a block diagram illustrating a process of resolution or aspect ratio conversion using the apparatus of FIG. 4. The process of converting the resolution will now be described with the assumptions that the image that corresponds to the DVD reproducing signal initially has a resolution of 480×720 and that the controlling unit 400-3 receives a signal from the user to convert the resolution to 720×1280. Referring to FIG. 5, the signal conversion unit 400-2 converts the resolution of the image corresponding to the DVD reproducing signal from 480×720 to 720×1280 via the control of the controlling unit 400-3. While the signal conversion unit 400-2 converts the resolution, the controlling unit 400-3 transmits the picture stored in the memory 400-1 to the digital television 401. When the resolution conversion is completed by the signal conversion unit 400-2, the controlling unit 400-3 stops transmitting the picture stored in the memory 400-1 and transmits the DVD reproducing signal with the resolution of 720×1280 to the digital television 401.

The process of converting the aspect ratio will now be described with the assumptions that the image that corresponds to the DVD reproducing signal initially has an aspect ratio of 4:3 and the controlling unit 400-3 receives a signal from the user to convert the aspect ratio to 16:9. The signal conversion unit 400-2 converts the aspect ratio of the image that corresponds to the DVD reproducing signal from 4:3 to 16:9 via the control of the controlling unit 400-3. While the signal conversion unit 400-2 converts the aspect ratio, the controlling unit 400-3 transmits the picture stored in the memory 400-1 to the digital television 401. Therefore, the digital television 401 outputs a predetermined picture instead of an abnormal picture. When the conversion of the aspect ratio is completed by the signal conversion unit 400-2, the controlling unit 400-3 stops transmitting the picture stored in the memory 400-1 and transmits the DVD reproducing signal with the aspect ratio of 16:9 to the digital television 401.

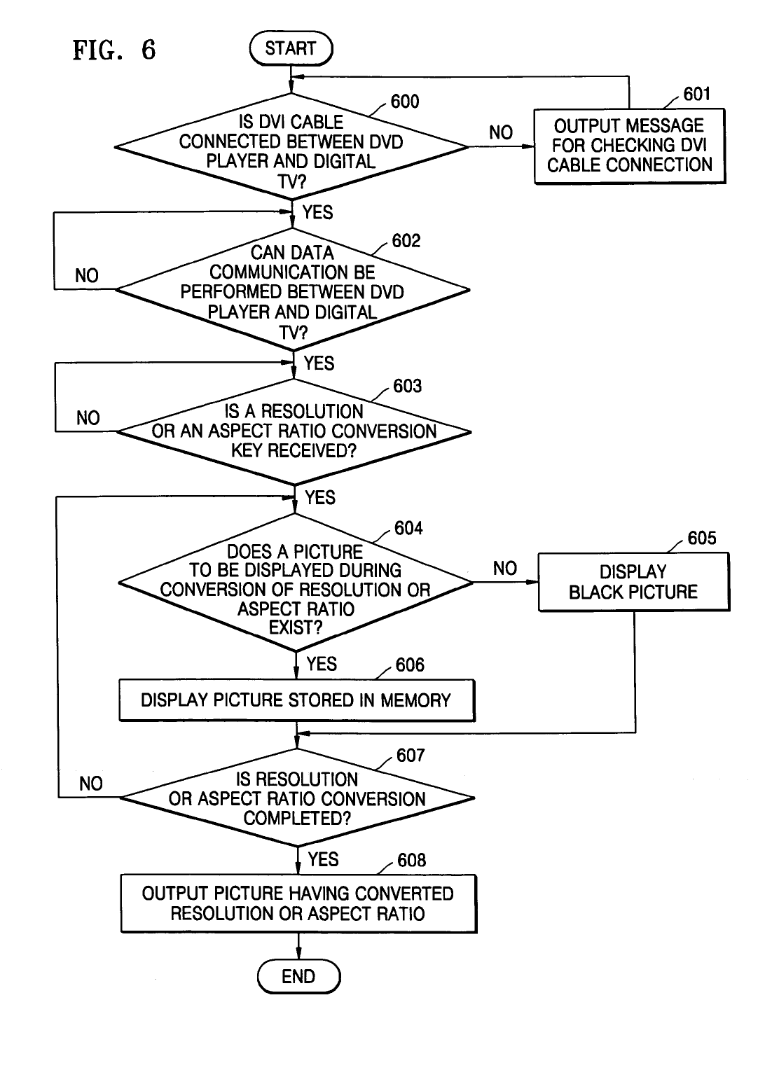

FIG. 6 is a flow chart illustrating a method of converting an output picture according to a second embodiment of the present invention.

The controlling unit 400-3 of the DVD player 400 determines whether the DVI cable 402 is connected to the digital television 401 and the DVD player (step 600).

The controlling unit 400-3 can determines the connection of digital television 401 via the hotplug channel of the DVI cable 402. For example, if the controlling unit 400-3 receives a signal of 5V through the hotplug channel, it determines that the DVI cable 402 is connected to the digital television 401.

When the DVI cable 402 is not connected to the digital television 401 or the DVD player 400, that is, when the controlling signal 400-3 receives a 0V signal via the hotplug channel, the controlling unit 400-3 determines that the DVI cable is not connected to the digital television 401 or the DVD player 400, and outputs a message for checking the connection (step 601).

When the digital television 401 and DVD player 400 are connected to the DVI cable 402, the controlling unit 400-3 determines whether data communication with the digital television 401 can be performed (step 602).

The DVD player 400 and the digital television 401 perform communication via the DVI cable 402, and the controlling unit 400-3 can determine whether the data communication can be performed with the digital television 401 through the data channels of the DVI cable 402.

If the DVI cable 402 is connected to the digital television 401 and the data communication with the digital television 401 can be performed, the controlling unit 400-3 transmits a DVD reproducing signal to the digital television 401 via the data channel of the DVI cable 402.

In addition, the controlling unit 400-3 determines whether the output image conversion information such as the resolution conversion or the aspect ratio conversion from the user (step 603).

If the controlling unit 400-3 receives the output image information, the controlling unit 400-3 determines whether there is a picture in the memory 400-1 to be displayed by accessing the memory 400-1 while the resolution or the aspect ratio is being converted (step 604).

If the controlling unit 400-3 determines that there is no picture to be displayed in step 604, the controlling unit 400-3 transmits the black image to the digital television 401 (step 605). Otherwise, the controlling unit 400-3 transmits the image stored in the memory 400-1 (step 606).

If When the controlling unit 400-3 receives the output picture conversion information via a user key, the signal conversion unit 400-2 converts the DVD reproducing signal in response to the output picture conversion information. While the DVD reproducing signal is being converted to be suitable for the output picture conversion information, the controlling unit 400-3 accesses the memory 400-1. The memory 400-1 may store various image information, and may store an image input by the user. Therefore, while the DVD reproducing signal is being converted, the controlling unit 400-3 transmits a discretionary image from the image information stored in the memory 400-1 to the digital television 401 through the DVI cable 402.

When the resolution or the aspect ratio conversion is complete, the controlling unit 400-3 transmits the DVD reproducing signal which includes the image with the converted resolution or aspect ratio to the digital television 401 (step 608).

For example, it is assumed that the image that corresponds to the DVD reproducing signal initially has a resolution of 480×720 and that the controlling unit 400-3 receives a signal from the user to convert the resolution to 720×1280. Referring to FIG. 5, the signal conversion unit 400-2 converts the resolution of the image corresponding to the DVD reproducing signal from 480×720 to 720×1280 via the control of the controlling unit 400-3. While the signal conversion unit 400-2 converts the resolution, the controlling unit 400-3 transmits the picture stored in the memory 400-1 to the digital television 401. When the resolution conversion is completed by the signal conversion unit 400-2, the controlling unit 400-3 stops transmitting the picture stored in the memory 400-1 and transmits the DVD reproducing signal with the resolution of 720×1280 to the digital television 401.

The process of converting the aspect ratio will now be described with the assumptions that the image that corresponds to the DVD reproducing signal initially has an aspect ratio of 4:3 and the controlling unit 400-3 receives a signal from the user to convert the aspect ratio to 16:9 The signal conversion unit 400-2 converts the aspect ratio of the image that corresponds to the DVD reproducing signal from 4:3 to 16:9 via the control of the controlling unit 400-3. While the signal conversion unit 400-2 converts the aspect ratio, the controlling unit 400-3 transmits the picture stored in the memory 400-1 to the digital television 401. Therefore, the digital television 401 outputs a predetermined picture instead of an abnormal picture. When the conversion of the aspect ratio is completed by the signal conversion unit 400-2, the controlling unit 400-3 stops transmitting the picture stored in the memory 400-1 and transmits the DVD reproducing signal with the aspect ratio of 16:9 to the digital television 401.

1. A method of converting an output image, output by digital image reproducer connected to a digital television via a digital interface cable, the method comprising:
receiving output picture conversion information after data communication with the digital television commences;
transmitting predetermined image information to the digital television while an output image of a digital image reproducing signal is being converted in response to the output picture conversion information, the predetermined image information being other than the output image being converted; and
interrupting the transmission of the predetermined image information and transmitting the converted output image to the digital television when the conversion of the output image is completed.

2. The method of claim 1, wherein the received output picture conversion information comprises information that provides instructions to convert a resolution of the output image to another resolution.

3. The method of claim 2, wherein, the transmitting the predetermined image information comprises transmitting the predetermined image information to the digital television while converting the digital image reproducing signal to produce the output image with the another resolution.

4. The method of claim 1, wherein the received output picture conversion information comprises information that provides instructions to convert the aspect ratio of the output image to another aspect ratio.

5. The method of claim 4, wherein, the transmitting the Predetermined image information comprises transmitting the predetermined image picture information to the digital television while the digital image reproducing signal is being converted to produce the output image with the another aspect ratio.

6. An apparatus that converts an output picture output from a digital image reproducer, connected a digital television via a digital interface cable, comprising:
a memory storing predetermined image information;
a signal conversion unit that converts an output image of a digital image reproducing signal in response to a controlling signal; and
a controlling unit that determines whether the digital interface cable is connected to the digital image reproducer and the digital television and whether data communication with the digital television can be performed, receives output picture conversion information, outputs the controlling signal, to convert the output image of the digital image reproducing signal in response to the received output picture conversion information, and transmits the predetermined image information stored in the memory to the digital television while the output image is being converted.

7. The apparatus of claim 6, wherein, when the output picture conversion is complete, the controlling unit stops transmitting the predetermined image information and transmits the converted output image to the digital television.

8. The apparatus of claim 6, wherein the output picture conversion information received from the controlling unit is information that provides instructions to convert a resolution of the output image to another resolution.

9. The apparatus of claim 8, wherein the controlling unit transmits the predetermined image information stored in the memory to the digital television while the digital image reproducing signal is being converted to reproduce the output image with the another resolution.

10. The apparatus of claim 6, wherein the output picture conversion information received by the controlling unit is information that provides instructions to convert an aspect ratio of the output image to another aspect ratio.

11. The apparatus of claim 10, wherein the controlling unit transmits the predetermined image information stored in the memory to the digital television while the digital image reproducing signal is being converted to produce the output image with the another aspect ratio.

12. A method of converting an output of a reproducing apparatus having first visual properties for use on a display having second visual properties, the method comprising:
while converting the output having the first visual properties to have the second visual properties used by the display, transmitting to the display a predetermined image other than an image generated as the output is being converted; and
interrupting the transmission of the predetermined image and transmitting the converted output having the second visual properties to the display when the conversion is completed.

13. The method of claim 12, further comprising receiving a conversion request, wherein the converting of the output and the transmitting the predetermined image are initiated when the conversion request is received.

14. The method of claim 12, further comprising, while converting the output, retrieving from a memory the predetermined image to be transmitted to the display.

15. The method of claim 12, wherein the first visual properties comprises a first aspect ratio and the second visual properties comprises a second aspect ratio other than the first aspect ratio, wherein the display uses the second aspect ratio and the output of the reproducing apparatus uses the first aspect ratio.

16. The method of claim 15, wherein one of the first and second aspect ratios is a 4:3 aspect ratio, and the other one of the first and second aspect ratios is a 16:9 aspect ratio.

17. The method of claim 12, wherein the first visual properties comprises a first resolution and the second visual properties comprises a second resolution other than the first resolution, wherein the display uses the second resolution and the output of the reproducing apparatus uses the first resolution.

18. The method of claim 17, wherein one of the first and second resolutions is a 480×720 resolution, and the other one of the first and second resolutions is a 720×1280 resolution.

19. The method of claim 12, further comprising establishing a connection between the reproducing apparatus and the display.

20. A conversion apparatus for use in converting an output from a reproducing apparatus having first visual properties for use on a display having second visual properties, comprising:
a signal conversion unit that converts between the first visual properties and the second visual properties; and
a controlling unit that controls the signal convention unit to convert the output to have the second visual properties, while the signal conversion unit is converting between the first and second visual properties of the output, transmits to the display a predetermined image other than an image generated as the output is being converted, and, when the signal conversion unit has completed converting between the first and second visual properties for the output, interrupts the transmission of the predetermined image and transmitting the converted output having the second visual properties to the display.

21. The conversion apparatus of claim 20, wherein the controlling unit further, prior to transmitting the predetermined image, retrieves the predetermined image from a memory storing the predetermined image.

22. The conversion apparatus of claim 20, wherein the controlling unit further, prior to transmitting the predetermined image:
checks for image information stored in a memory,
if the memory has the image information, retrieves the image information from the memory to be the transmitted predetermined image, and
if the memory does not have the image information, a preset screen display not stored in the memory is the transmitted predetermined image.

23. The conversion apparatus of claim 20, wherein the controlling unit receives a conversion request, and controls the signal conversion unit to begin converting the output and the starts transmitting the predetermined image when the conversion request is received.

24. The conversion apparatus of claim 20, wherein the first visual properties comprises a first aspect ratio and the second visual properties comprises a second aspect ratio other than the first aspect ratio, wherein the display uses the second aspect ratio and the output of the reproducing apparatus uses the first aspect ratio.

25. The conversion apparatus of claim 24, wherein one of the first and second aspect ratios is a 4:3 aspect ratio, and the other one of the first and second aspect ratios is a 16:9 aspect ratio.

26. The conversion apparatus of claim 20, wherein the first visual properties comprises a first resolution and the second visual properties comprises a second resolution other than the first resolution, wherein the display uses the second resolution and the output of the reproducing apparatus uses the first resolution.

27. The conversion apparatus of claim 26, wherein one of the first and second resolutions is a 480×720 resolution, and the other one of the first and second resolutions is a 720×1280 resolution.

28. The conversion apparatus of claim 20, wherein the controlling unit further ensures a connection exists between the reproducing apparatus and the display before transmitting the predetermined image.

29. A reproducing apparatus which reads medium having stored data having first visual properties and reproduces the read data to produce an output, and including the conversion apparatus of claim 20 for use in converting the output for use on a display having second visual properties.

30. A display which receives from a reproducing apparatus an output having first visual properties and including the conversion apparatus of claim 20 for use in converting the output for to be displayed using second visual properties.
